(19) United States
(12) Patent Application Publication
(10) Pub. No.: US 2012/0033246 A1
(43) Pub. Date: Feb. 9, 2012

(54) APPARATUS, METHOD, AND PROGRAM FOR SIZE DETECTION

(75) Inventor: Kouichi Unno, Yokohama-shi (JP)

(73) Assignee: CANON KABUSHIKI KAISHA, Tokyo (JP)

(21) Appl. No.: 13/191,371

(22) Filed: Jul. 26, 2011

(30) Foreign Application Priority Data
Aug. 4, 2010 (JP) 2010-175540

(51) Int. Cl. G06K 15/02; H04N 1/40

(52) U.S. Cl. 358/1.14; 358/449

(57) ABSTRACT

An apparatus includes a size detector configured to detect a size of an original on a contact glass when an angle of a pressing plate is within a predetermined range, a storage element configured to store information of the detected size of original, a reader configured to read the original on the contact glass, using the information of the stored size of the original, after a log-on, and a storage updater configured to update the stored size of the original, along with a log-off.

### BACKGROUND OF THE INVENTION

1. Field of the Invention

Embodiments of the present invention relate to an apparatus, a method, and a program for size detection.

2. Description of the Related Art

Referring to FIG. 1, a conventional technique will be described. Conventionally, a technique for detecting a size of an original 103 placed on a contact glass 102 (which is discussed in Japanese Patent Application Laid-Open No. 2-167536) is known. In this technique, the size of the original 103 is detected when a pressing plate 101 is closed, using a transmissive sensor 104.

To describe a specific detection method, a state as illustrated FIG. 1 is assumed. Specifically, the original 103 is placed on the contact glass 102, and the pressing plate 101 is sufficiently opened (e.g., with a clearance of about 60°).

In this state, a strong external light will enter into transmissive sensor 104 arranged under the contact glass 102. The transmissive sensor 104 is used to detect a size of the original 103 placed on the contact glass 102 by emitting an infrared light that is invisible to human eyes and receiving a reflected light thereof. However, in a state where the pressing plate 101 is sufficiently opened in this way, accurate size detection cannot be carried out due to an influence of the strong external light.

On the other hand, a state where the pressing plate 101 is completely closed (e.g., with a clearance of about 0°), or a state where the pressing plate 101 is opened just a little (e.g., with a clearance of about 3°) is assumed. In such a case, since there is no influence of the external light, accurate size detection can be possibly performed. However, when the transmissive sensor 104 emits the infrared light under such a state, the infrared light not only strikes the original 103 and returns to the transmissive sensor 104, but also strikes the pressing plate 101 and returns to the transmissive sensor 104. Both cannot be distinguished from each other, and the transmissive sensor 104 may be unable to detect a size of the original.

Finally, a state where the pressing plate 101 is opened (e.g., with a clearance of about 45°) is assumed. In such a case, out of the infrared light emitted by the transmissive sensor 104, a light which has struck the pressing plate 101, escapes toward the outside (clearance between the pressing plate 101 and the contact glass 102). On the other hand, a light which has struck the original 103, will return toward the transmissive sensor 104. As a result, the transmissive sensor can receive only the reflected light from the original 103, and accordingly it will be able to detect a size of the original. In the state where such the pressing plate 101 is opened, the external light will enter into the transmissive sensor 104, but an amount of the light will become relatively small. In other words, the amount of the external light become smaller in comparison with the reflected light and it can be neglected. The reflected light is a returned light after the light emitted by the transmissive sensor 104 has struck the original 103.

Hereinbefore, original size detecting technique has been briefly described, but such a technique has been conventionally known. There is also discussion in Japanese Patent Application Laid-Open No. 2-167536 set forth below.

However, even with such original size detecting technique, outputs of incorrect original sizes may occur from time to time. For example, the following situation may occur. A user places a first original on a contact glass, closes a pressing plate and instructs an output (e.g., copy output or mail transmission). Assuming everything is done properly, detection of correct original size may be performed, and correct output may be produced.

Thereafter, suppose the user opens the pressing plate just a little (e.g., with a clearance of about 3°) and removes the first original. Then, suppose the same user or another user places a second original different from the first original on the contact glass by utilizing a bare clearance thereof, closes the pressing plate and instructs an output.

Then, an output of incorrect original size may be produced. This may be because, when the pressing plate is opened only slightly, the size of the first original is still stored, and a size of the second original may not be detected. As a result, the size of the first original may be used as the size of the second original.

### SUMMARY OF THE INVENTION

One disclosed aspect of an embodiment of the present invention is directed to providing a configuration for producing an output with a correct size of an original.

According to a disclosed aspect of one embodiment, an apparatus includes a size detector configured to detect a size of an original on a contact glass when an angle of a pressing plate is within a predetermined range, a storage element configured to store information of the detected size of the original, a reader configured to read the original on the contact glass, using the information of the stored size of the original, after a log-on, and a storage updater configured to update the stored size of original, along with a log-off.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a view for explaining a configuration in the conventional technique.

FIG. 2 is a system block diagram as an exemplary embodiment of the present invention.

FIG. 3 is a configuration view for original size detection.

FIG. 4 is a flowchart of original size detection.

FIG. 5 is a processing flowchart as an exemplary embodiment of the present invention.

FIG. 6 is a configuration view of an operation unit.

FIG. 7 is a table for explaining an algorithm for original detection.

FIG. 8A illustrates a state of the storage region on a memory of detected original size before original detection.

FIG. 8B illustrates a state of the storage region on the memory when A4 original is detected by way of an example.

FIG. 8C illustrates a state of the storage region on the memory when B4 original is detected by way of an example.

FIG. 9 illustrates a state of the storage region on the memory of authentication information as an exemplary embodiment of the present invention.

FIG. 10 illustrates a registration screen of a division ID as an exemplary embodiment of the present invention.

FIG. 11A illustrates a log-in screen as an exemplary embodiment of the present invention.

FIG. 11B illustrates a copy screen when an original size is not being detected as an exemplary embodiment of the present invention.

FIG. 11C illustrates a copy screen when an original size is being detected as A4 as an exemplary embodiment of the present invention.

FIG. 11D illustrates an original size selection screen during copying operation as an exemplary embodiment of the present invention.

FIG. 12 illustrates a scanner control unit as an exemplary embodiment of the present invention.

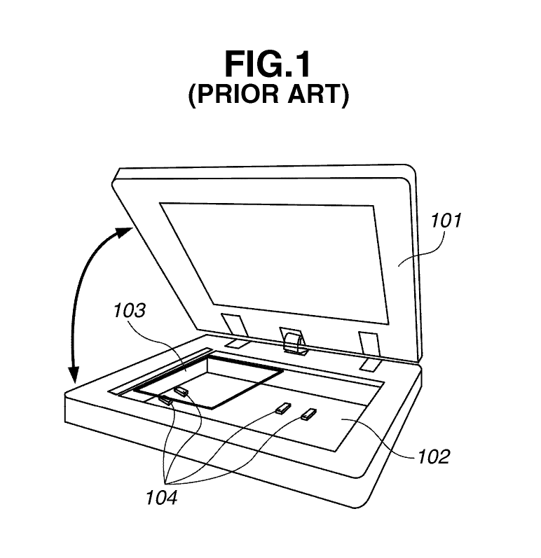

### DESCRIPTION OF THE EMBODIMENTS

Various exemplary embodiments, features, and aspects of the invention will be described in detail below with reference to the drawings.

One disclosed feature of the embodiments may be described as a process which is usually depicted as a flowchart, a flow diagram, a structure diagram, or a block diagram. Although a flowchart may describe the operations as a sequential process, the operations may be performed in parallel or concurrently. In addition, the order of the operations may be re-arranged. A process is terminated when its operations are completed. A process may correspond to a method, a program, a procedure, a method of manufacturing or fabrication, a sequence of operations performed by an apparatus, a machine, or a logic circuit, etc.

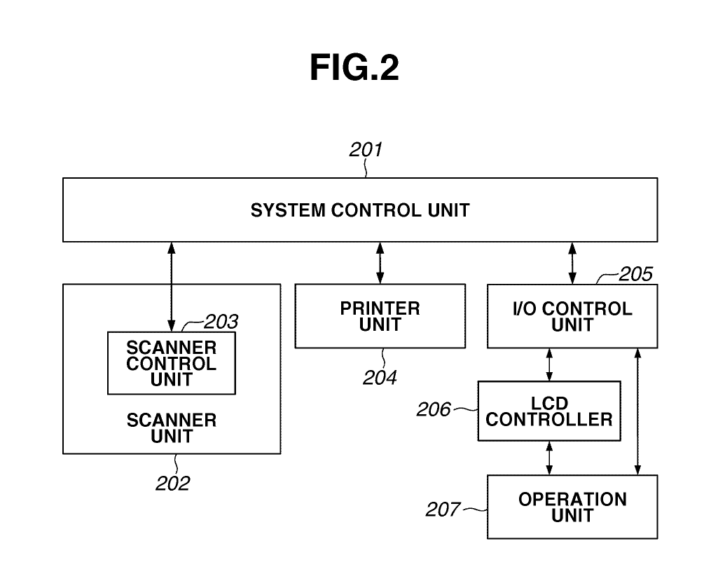

FIG. 2 illustrates a system block diagram of an exemplary embodiment. An image forming apparatus or system includes a system control unit 201, a scanner unit 202, a printer unit 204, an input/output (I/O), control unit 205, a liquid crystal display (LCD) controller 206, and an operation unit 207. The image forming apparatus may include more or less than the above components. The system control unit 201 performs various control functions on the scanner unit 202, the printer unit 204, the I/O control unit 205, and other components in the system. The scanner unit 201 performs scanning function including sensing and detecting sizes of originals. The scanner unit 201 includes a scanner control unit 203 that performs scan control functions and interfaces with the system control unit 201, as will be described in the following. The printer unit 204 performs printing function under the control of the system control unit 201. The I/O control unit 205 performs various I/O control functions including interacting with the LCD controller 206 and the operation unit 207. The LCD controller 206 performs control functions on a LCD panel such as displaying menu items for user selection. The operation unit 207 provides operational control functions such as mode setting, authentication, user interface, etc.

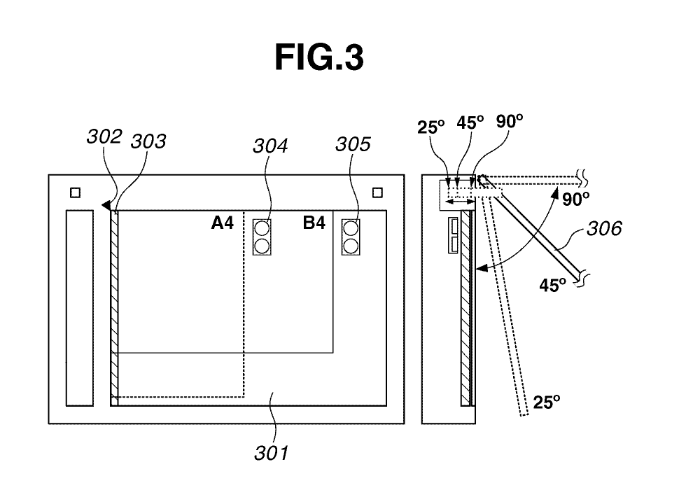

FIG. 3 illustrates a configuration of a scanner unit 202. The scanner unit 202 includes a contact glass 301, an index mark 302, a charge-coupled device (CCD) sensor 303, a transmissive sensor unit A 304 having a sensor that detects a reflection of the infrared light, a transmissive sensor unit B 305, and a pressing plate 306. In addition to these components, the scanner unit 202 is equipped with the scanner control unit 203 that detects states of the CCD sensor 303, the transmissive sensor unit A 309, and the transmissive sensor unit B 305 and an opening/closing angle of the pressing plate 306. Further, each of the transmissive sensor units is also equipped with light emitting elements that emit the infrared light, and accordingly each can not only receive but also emit the infrared light.

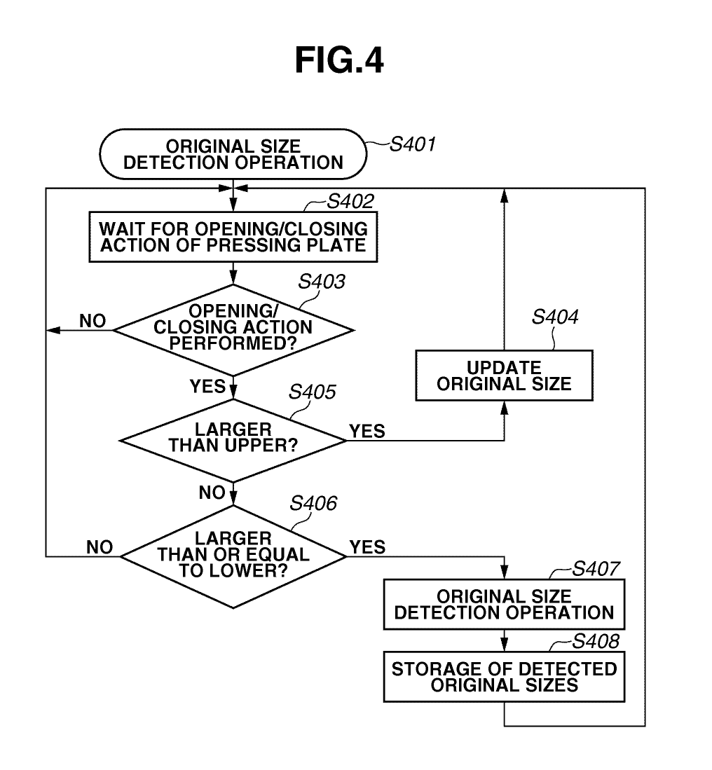

Hereinbelow, a method for detecting a size of the original placed on the contact glass 301 will be described with reference to FIG. 4. The original may be any article or object that is being scanned or copied, such as a sheet of paper, a book, a document, a picture, etc. The method includes an original size detection operation S401. In operation S402, the scanner control unit 203 monitors opening/closing action of the pressing plate by monitoring an angle of the pressing plate 306. In operation S403, when the opening/closing action of the pressing plate 306 is performed, the scanner control unit 203 detects this action. Then, in operation S905, if the scanner control 203 unit determines that an angle of the pressing plate 306 is larger than or equal to an upper angle threshold or a first threshold (e.g., an angle value of 45°) (YES in operation S405), the processing proceeds to operation S404. Then in operation S404, the scanner control unit 203 performs notification to the system control unit 201. Thereupon, the system control unit 201 updates (e.g., clears) or causes to update the size of the original which is registered, or stored, at the completion of operation S404). In other words, the system control unit 201 changes or causes to change a storage state so that the original size becomes “Unknown”. If no sizes of originals registered within the system control unit 201 at this time are present, no state change may be performed in operation S404.

On the other hand, if the scanner control unit 203 determines that an angle of the pressing plate 306 is less than the upper angle threshold but larger than or equal to a lower angle threshold or a second threshold (e.g., an angle value of)25° (YES in operation S406), then in operation S407, the scanner control unit 203 performs original size detecting operation. More specifically, first, the scanner control unit 203 reads an end of the original only a little using the CCD sensor 303, and receives the read image from the CCD sensor 303. The scanner control unit 203 calculates a height of the original using this received image (the height may be sometimes referred to a length detected by CCD) (act 1). In addition, the scanner control unit 203 performs command to the transmissive sensor unit A 304, and causes it to emit the infrared light invisible to human eyes. If a sensor of the transmissive sensor unit A 304 detects the reflected light, a notification that the reflected light has been detected is sent out to the scanner control unit 203 (act 2). Similarly, if the transmissive sensor unit B 305 detects an emission of the infrared light and a reflection of the emitted infrared light, a notification of the detection is sent out to the scanner control unit 203 (act 3).

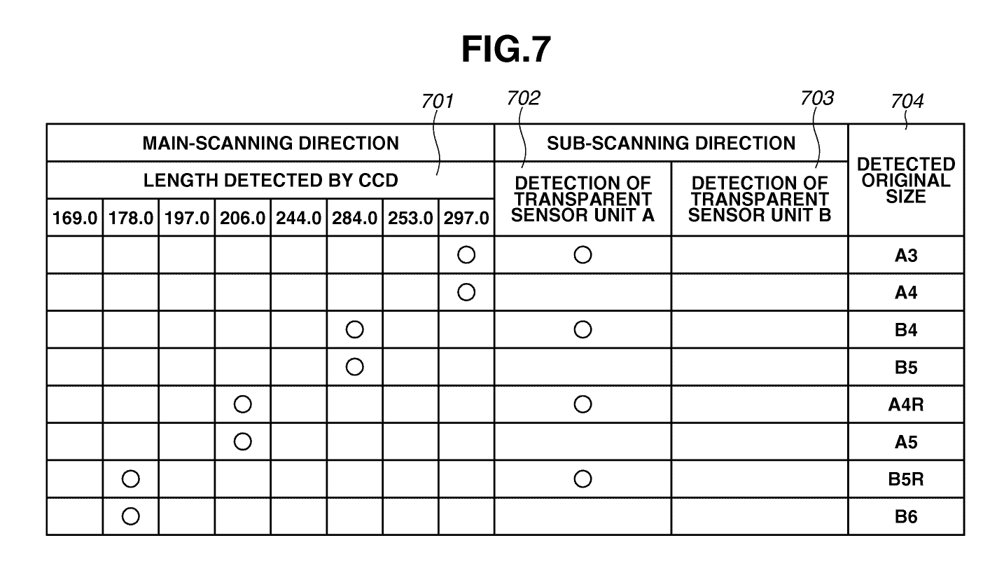

In light of these pieces of information obtained in act 1, act 2, and act 3, the scanner control unit 203 identifies a size of the original further using a table in FIG. 7. For example, when an A4 size original is placed on the contact glass 301, the scanner control unit 203 calculates a length detected by CCD as 297.0 mm. On the other hand, the transmissive sensor unit A and the transmissive sensor unit B are arranged at offset location from the A4 original, and accordingly, even if they would emit an infrared light, they would not detect a reflection of the infrared light. As a result, the scanner control unit 203 searches boxes having 297.0 mm as a length detected by CCD 701 and having neither a detection of transmissive sensor unit A 702, nor a detection of transmissive sensor unit B 703 (boxes with no ∘ marks) from the table in FIG. 7. Then, the scanner control unit 203 determines a detected original size 704 as A4. In addition, if a detected result does not fall under any box of the table in FIG. 7 (e.g., if the transmissive sensor unit B detects an infrared light, it does not fall under any box), the scanner control unit 203 determines that the original size is “Unknown”. Then, the scanner control unit 203 informs the determination result to the system control unit 201. Then, the system control unit 201 stores these determination results (original sizes).

The reason why, even when an opening/closing angle of the pressing plate 306 is equal to or close to the lower angle threshold (e.g., 25°), original size detection is performed in this way is because that has a higher accuracy (less affected by the external light). On the other hand, the reason why the original size detection is performed even at equal to or close to the upper angle threshold (e.g., 45°) is because, when the original is a thick article or object such as a dictionary or a book, an opening/closing angle of the pressing plate 306 may exceed 25°. The angles of 25° and 45° are only examples of the predetermined thresholds. In summary, the operations S407 and S408 may be performed when the angle θ of the pressing plate 306 with respect to the contact glass is within a predetermined range, such as θ₂<θ<θ₁, where θ₁ and θ₂ represent the upper and lower angle thresholds, respectively.

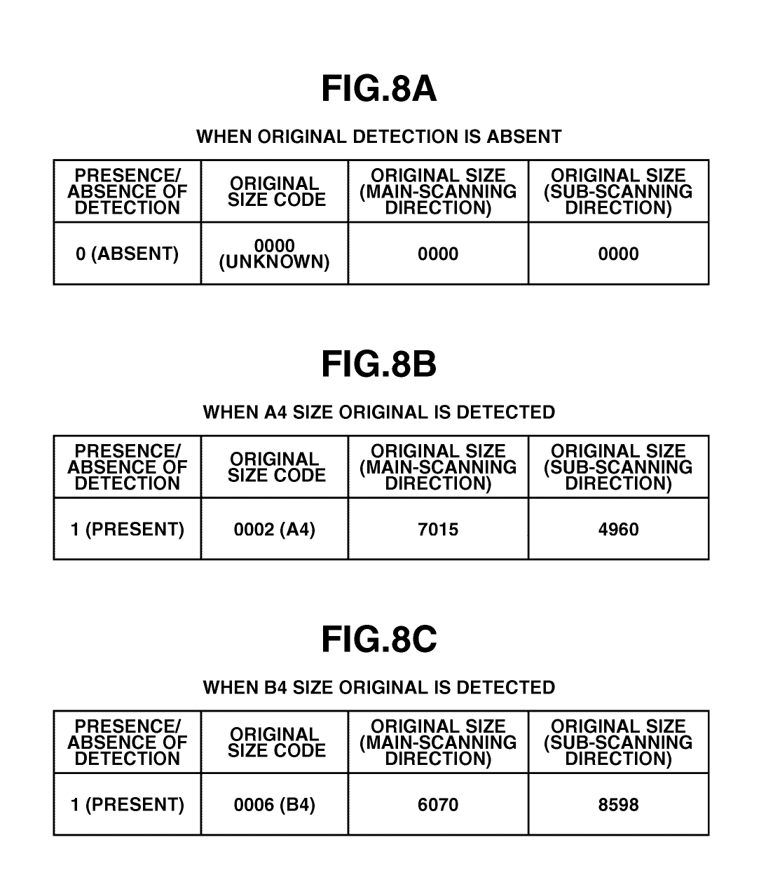

The original size on the contact glass 301 thus detected by the scanner control unit 203 is notified from the scanner control unit 203 to the system control unit 201. Then, the system control unit 201 stores the detected original size on the contact glass 301, in a memory arrangement as illustrated in FIG. 8B or 8C in the memory of the system control unit 201 on the basis of the notified information.

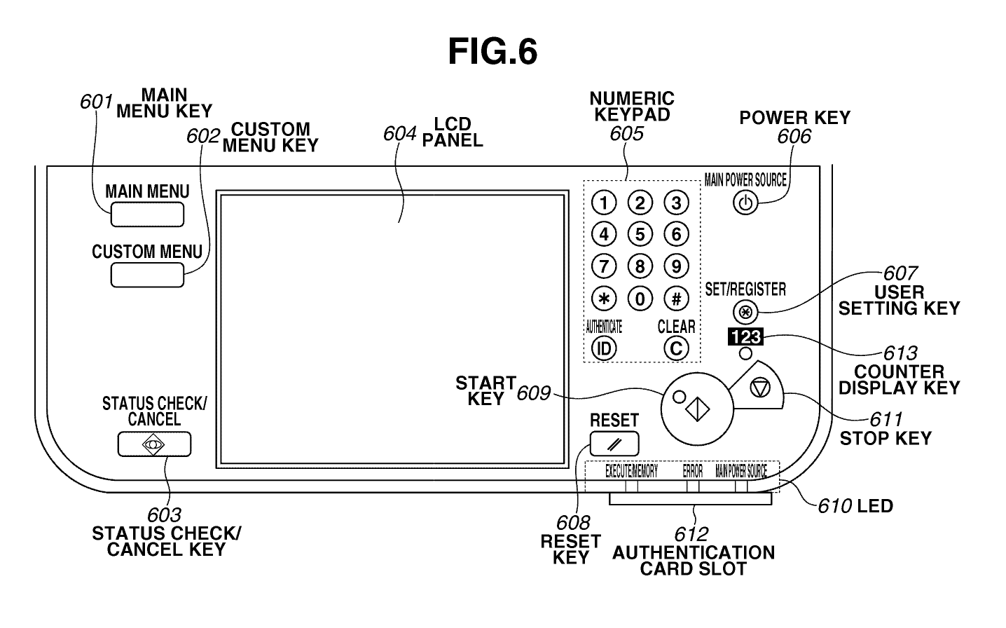

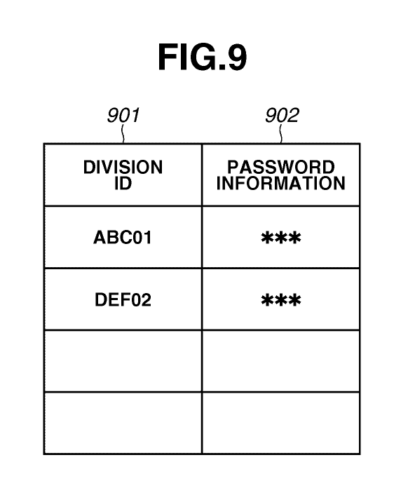

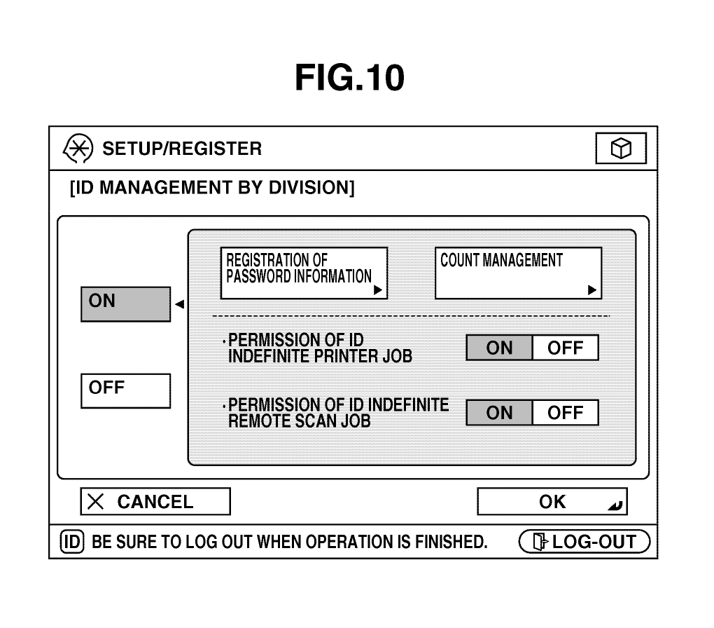

Next, an operation the image forming apparatus when an authentication operation is performed, will be described. In order for the user to use the image forming apparatus, the authentication operation may be performed. When the user performs authentication operation (when a division ID and password information are input) using the operation unit 207 (e.g., using keys 601 to 613) in FIG. 6, the operation unit 207 sends the information to the system control unit 201 via the I/O control unit 205. Then, the system control unit 201 compares the received result with data for authentication (e.g., data registered in advance) illustrated in FIG. 9. If matching of both of a division identification (ID) 901 and password information 902 has been confirmed, the image forming apparatus goes into an authentication ON (log-on) state. In other words, the system control unit 201 will store the information of authentication ON. If the matching has not been confirmed, the image forming apparatus remains in an authentication OFF state.

In the present exemplary embodiment as described above, an authentication using a division ID has been performed, but an authentication using a user ID may be performed. In addition, there are some cases where password information is not necessary, depending on an installation location where the image forming apparatus is installed. In addition, an operation of passing ID card in place of input of ID, or, inserting fee into a fee insertion portion may be performed. As it will be understood that, an operation indicating that a certain user begins to use the image formation apparatus is being performed. In the present specification, such an operation is referred to as an authentication operation. As will be described in the following, the authentication operation may be carried out by an authenticator as part of the system control unit 201 or the scanning control unit 203.

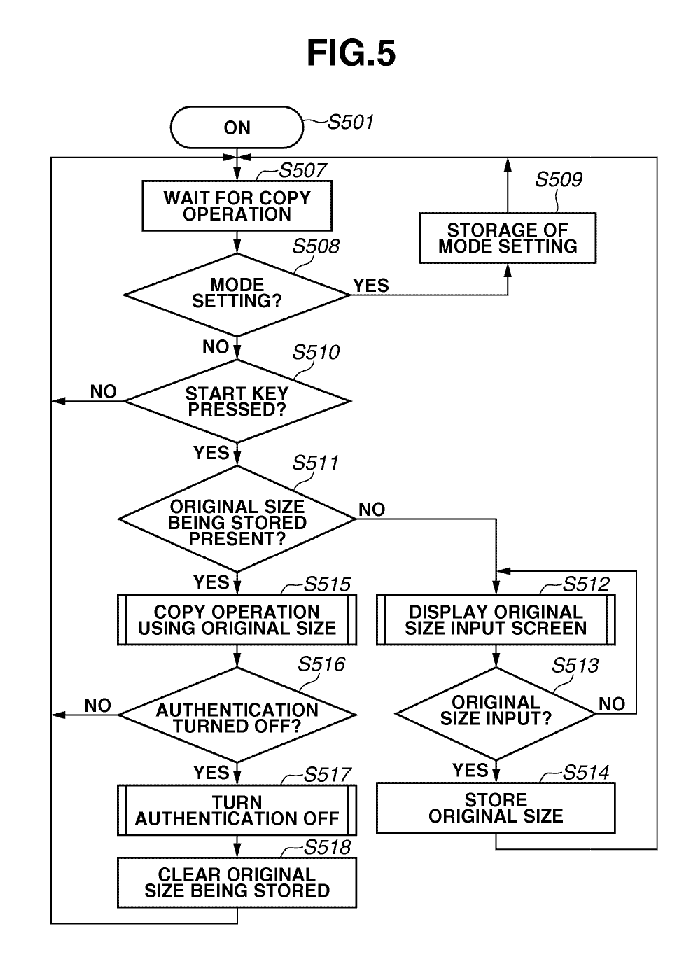

Hereinbelow, the flowchart in FIG. 5 will be described. In operation S501, authentication is turned ON. At this time, the image forming apparatus goes into a standby state, and waits for an authentication operation by the user. When the authentication operation is performed, and authentication is turned ON, then the processing proceeds to operation S507.

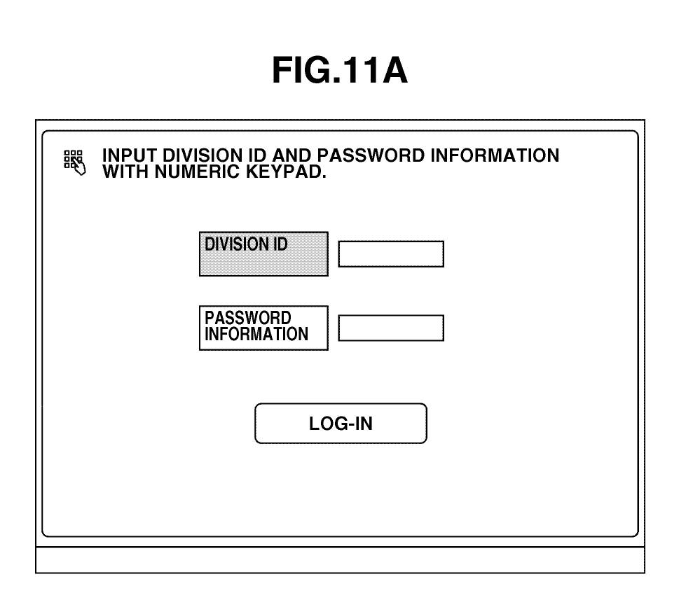

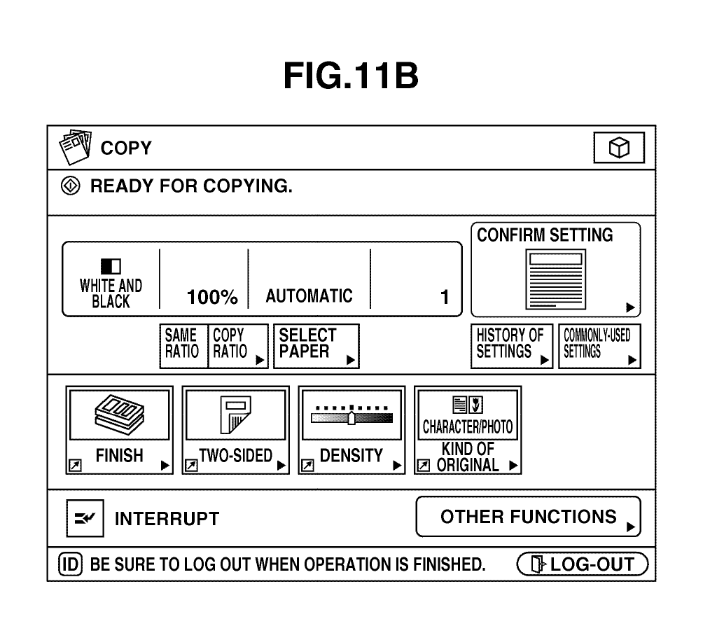

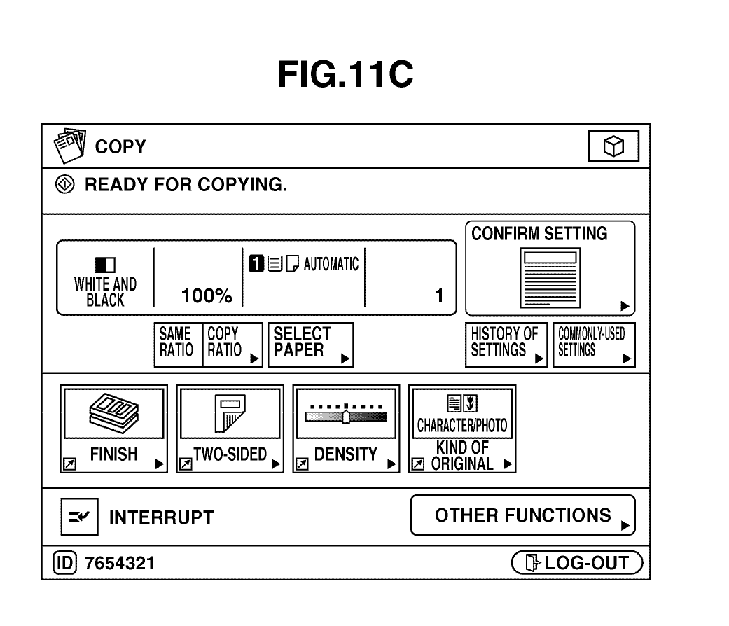

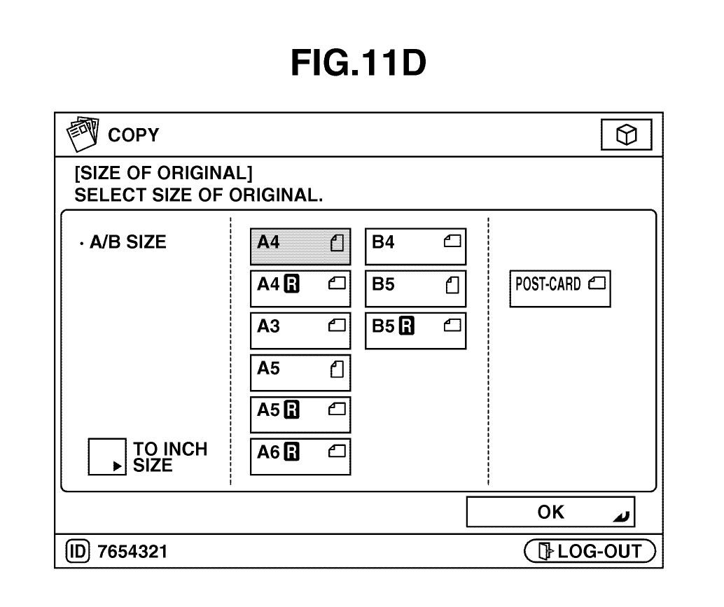

When the user places the original 300 on the contact glass 301 in the standby state, and performs opening/closing of the pressing plate 306 (YES in operation S403), then the scanner control unit 203 performs original size detection as described above, and notifies the system control unit 201 of the detected information. Then, in operation S408, the system control unit 201 stores the detected original size (see FIGS. 8B and 8C). At this time, the system control unit 201 sends a display screen as illustrated in FIG. 11B to a liquid crystal display (LCD) panel 604, via the I/O control unit 205 and the LCD controller 206. Then, the LCD panel 604 performs display of the display screen. FIG. 11B illustrates the display screen when the original is detected as A4 size.

Thereafter, when the user performs settings of a mode from the operation unit 207, the system control unit 201 receives the settings via the I/O control unit 205 or the LCD controller 206 (YES in operation S508). The settings include a magnification ratio and a number of copies. The system control unit 201, which has received the settings, changes the settings of default mode stored in advance in the system control unit 201 to the received settings in operation S509.

If the user presses a start key 609 within the operation unit 207, the information will be notified to the system control unit 201 via the I/O control unit 205. If the information has been notified (YES in operation S510), the processing proceeds to operation S511.

If the original size is not stored (NO in operation S511) in the system control unit 201 (original size is UNKNOWN), then in operation S512, the system control unit 201 sends the screen for allowing the user to input the original size on the LCD panel 604, via the I/O control unit 205 and the LCD controller 206. Then, the LCD panel 604 will display the screen, and an example of the screen is illustrated in FIG. 11D. When the above processing is completed, the image forming apparatus goes into a state of waiting for original size input.

In this process, when the user selects a size of the original being placed the contact glass 301, from FIG. 11D displayed on the LCD panel 604, the system control unit 201 receives its size via the LCD controller 206 and the I/O control unit 205. Then, in operation S514, the system control unit 201 stores information such as the one in FIG. 8B or 8C on the memory, then in operation S507, again goes into the user's operation standby state.

As it can be seen from the fact that FIG. 5 and FIG. 4 are separate flowcharts, both represent independent operations. Therefore, for example, even before proceeding to operation S501 in FIG. 5 (state of authentication ON), or even in a state in operation S507, an opening/closing of the pressing plate 306 is being accepted. When the opening/closing of the pressing plate 306 is performed, a size of the original will be stored. For this reason, when the opening/closing of the pressing plate 306 is performed, for example, in a state where a size of the original is stored in operation S514, the size which the user has input in operation S512 is once updated (e.g., cleared), and a size of the detected original will be stored.

If the scanner control unit 203 determines that the size of original is stored (YES in operation S511), the processing proceeds to operation S515, where copying or printing is performed. Specifically, a sheet with the same size as the original size being stored is pulled out, and image data obtained by scanning (e.g., reading) the original is printed on the sheet. In printing, the system control unit 201 causes the scanner unit 202 to scan or read the original, and causes the printer unit 204 to print the image data obtained by the scanning operation. The above descriptions cover a case where a magnification ratio is 100%. If a copy ratio is not 100%, pull-out of sheet is performed depending on both of the magnification ratio and the stored original size, and printing will be performed on the sheet. The printer unit 204 executes pull-out and printing of the sheet. Output modes other, than printing, such as FAX output, the Internet FAX output, E-mail transmission, may be used.

Thereafter, in operation S516, if the system control unit 201 detects that the “Log-Out” button at a lower right corner in FIG. 11B or FIG. 11C displayed on the LCD panel 604 has been pressed via the LCD controller 206 and the I/O control unit 205 (YES in operation S516), then in operation S517, the system control unit 201 turns the authentication state OFF. In other words, the system control unit 201 goes into a log-off state, which means that the system control unit 201 changes the authentication state from ON to OFF. The log-off state may be referred to as a release state. In addition, even when the log-out button is not pressed, the system control unit 201 may automatically shift to the log-off state when a fixed time has elapsed since the system control unit 201 went into the log-on state. Alternatively, when a fixed time has elapsed since the operation was lastly performed from the user in the log-on state, the system control unit 201 may automatically shift to the log-off state.

In operation S517, when the process become the log-off state in this way, the system control unit 201 displays the screen in FIG. 11A on the LCD panel 604, via the I/O control unit 205 and the LCD controller 206. In addition, the system control unit 201 changes the detected original size stored in such a memory arrangement in FIG. 8B or FIG. 8C on the memory of the system control unit 201, to “Unknown” state as illustrated in FIG. 8A, and returns again to a state of waiting for acceptance of user authentication operation (operation S507).

In the above-described exemplary embodiments, description of shift to log-off state→change original size to “Unknown” state has been given, but these states may occur simultaneously, or may occur in order of change original size to “Unknown” state→shift to log-off state. In either case, it is only necessary that the log-off state and the change occur in the course of a relatively short time (1), or even if not in a short time, it is only necessary that these continuously occur as a control (2). As a concept which includes the both cases, there is an expression of “along with”. If it is expressed as change an original size to “Unknown” state, along with the log-off, the above two cases will be included.

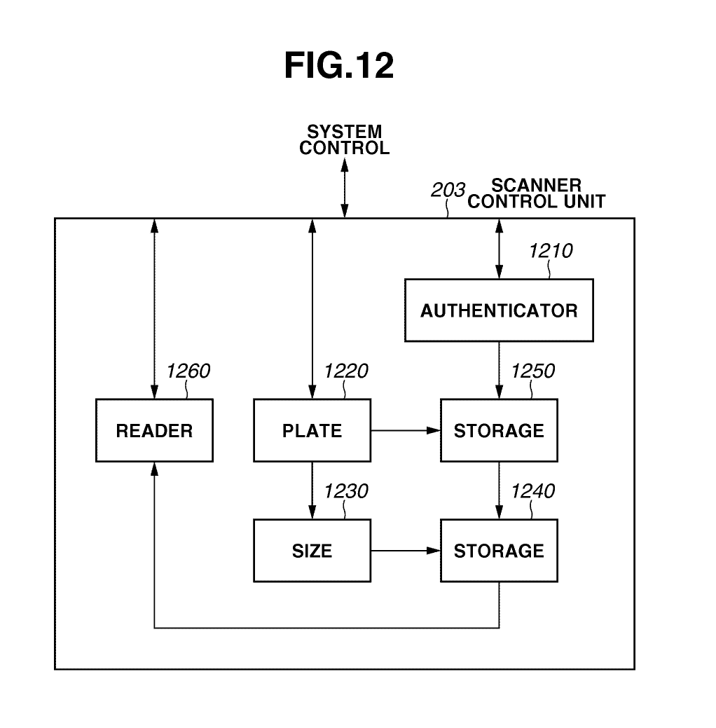

FIG. 12 illustrates the scanner control unit 203 as an exemplary embodiment. The scanner control unit 203 may include an authenticator 1210, a plate detector 1220, a size detector 1230, a storage element 1240, a storage updater 1250, and a reader 1260. The scanner control unit 203 may include or more less than the above components. In addition, some of the above components may be optional and/or located outside the scanner control unit 203. For example, the authenticator 1210 may be located in the system control unit 201 and the reader 1260 may be part of the scanner unit 202.

The authenticator 1210 may be configured to authenticate usage of the image forming apparatus by generating a log-on when the usage is authenticated and generating a log-off when the usage is not authenticated. When the usage is authenticated, the authentication is in an ON state and when the usage is not authenticated, the authentication is in an OFF state, as described in the authentication operation above. The authenticator 1210 may be implemented in the scanner control unit 203 or in the system control unit 201.

The plate detector 1220 may be configured to detect an opening or closing action of the pressing plate 306 and to determine the angle θ of the pressing plate 306 with respect to the contact glass 301.

The size detector 1230 may be configured to detect a size of an original on the contact glass 301 when the angle of the pressing plate 306 is within a predetermined range, such as when θ₂<θ<θ₁, where θ₁ and θ₂ are upper and lower angle thresholds, respectively.

The storage element 1240 may be configured to store information of the detected size of the original. When the size detector 1230 obtains the size of the original, it writes or stores the size information into the storage element 1240. The storage element 1240 may be a location on a memory device.

The storage updater 1250 may be configured to update the stored size of original, along with the log-off. The update may include operations such as clearing (e.g., resetting to some initial value such as zero), initializing, resetting, or setting to a pre-determined value or symbol (e.g., Unknown). The storage updater 1250 may receive commands, control signals, control codes, or instructions from the authenticator 1210 or the plate detector 1220 to update the storage element 1240. The reader 1260 may be configured to read the original on the contact glass 301, using the information of the stored size of the original from the storage element 1240, after the log-on. The reader 1260 may include elements of the scanner unit 202 such as the CCD sensor 303 or control circuit or module that controls the CCD sensor 303.

### Other Embodiments

Aspects of various exemplary embodiments may also be realized by a computer of a system or apparatus, or devices such as a central processing unit (CPU) or main processor unit/microprocessor unit (MPU) that reads out and executes a program or instructions recorded/stored on a memory device or a non-transitory storage medium to perform the operations or functions of the above-described embodiments, and by a method, the operations of which are performed by a computer of a system or apparatus by, for example, reading out and executing a program recorded/stored on a memory device to perform the functions of the above-described embodiments. The method may be a computerized method to perform the operations with the use of a computer, a processor, or a programmable device. The operations in the method involve physical objects or entities (e.g., an original, contact glass, pressing plate) representing a machine or a particular apparatus (e.g., image formation machine, copier, printer). In addition, the operations in the method transform the elements or parts in the image formation apparatus from one state to another state. For example, a size of an original representing a physical entity is transformed (e.g., detected, stored, and updated) into a stored size. For this purpose, the program/instructions is/are provided to the computer for example via a network or from a recording medium of various types serving as the memory device (e.g., computer-readable medium). In such a case, the system or apparatus, and the recording medium where the program is stored, are included as being within the scope of the present invention.

In addition, elements of one embodiment may be implemented by hardware, firmware, software or any combination thereof. The term hardware generally refers to an element having a physical structure such as electronic, electromagnetic, optical, electro-optical, mechanical, electro-mechanical parts, etc. A hardware implementation may include analog or digital circuits, devices, processors, applications specific integrated circuits (ASICs), programmable logic devices (PLDs), field programmable gate arrays (FPGAs), or any optical, electromechanical, electromagnetic, or electronic devices. The term software generally refers to a logical structure, a method, a procedure, a program, a routine, a process, an algorithm, a formula, a function, an expression, etc. A software implementation typically includes realizing the above elements (e.g., logical structure, method, procedure, program) as instruction codes and/or data elements embedded in one or more storage devices and executable and/or accessible by a processor, a CPU/MPU, or a programmable device as discussed above. The term firmware generally refers to a logical structure, a method, a procedure, a program, a routine, a process, an algorithm, a formula, a function, an expression, etc., that is implemented or embodied in a hardware structure (e.g., flash memory). Examples of firmware may include microcode, writable control store, micro-programmed structure. When implemented in software or firmware, the elements of an embodiment may be the code segments to perform the necessary tasks. The software/firmware may include the actual code to carry out the operations described in one embodiment, or code that emulates or simulates the operations.

All or part of an embodiment may be implemented by various means depending on applications according to particular features, functions. These means may include hardware, software, or firmware, or any combination thereof. A hardware, software, or firmware element may have several modules or units coupled to one another. A hardware module/unit is coupled to another module/unit by mechanical, electrical, optical, electromagnetic or any physical connections. A software module/unit is coupled to another module by a function, procedure, method, subprogram, or subroutine call, a jump, a link, a parameter, variable, and argument passing, a function return, etc. A software module/unit is coupled to another module/unit to receive variables, parameters, arguments, pointers, etc. and/or to generate or pass results, updated variables, pointers, etc. A firmware module/unit is coupled to another module/unit by any combination of hardware and software coupling methods above. A hardware, software, or firmware module/unit may be coupled to any one of another hardware, software, or firmware module/unit. A module/unit may also be a software driver or interface to interact with the operating system running on the platform. A module/unit may also be a hardware driver to configure, set up, initialize, send and receive data to and from a hardware device. An apparatus may include any combination of hardware, software, and firmware modules/units.

While exemplary embodiments of the present invention have been described with reference to illustrations, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-175540 filed Aug. 4, 2010, which is hereby incorporated by reference herein in its entirety.

What is claimed is:

1. An apparatus comprising:
a size detector configured to detect a size of an original on a contact glass when an angle of a pressing plate is within a predetermined range;
a storage element configured to store information of the detected size of the original;
a reader configured to read the original on the contact glass, using the information of the stored size of the original, after a log-on; and
a storage updater configured to update the stored size of the original, along with a log-off.

2. The apparatus of claim 1 further comprising:
an authenticator configured to authenticate usage by generating the log-on when the usage is authenticated and generating the log-off when the usage is not authenticated.

3. The apparatus of claim 1 further comprising:
a plate detector configured to detect an opening or closing action of the pressing plate and to determine the angle of the pressing plate.

4. A method comprising:
detecting a size of an original on a contact glass when an angle of a pressing plate is within a predetermined range;
storing information of the detected size of original;
reading the original on the contact glass, using the information of the stored size of the original after a log-on; and
updating the stored size of the original, along with a log-off.

5. The method of claim 4 further comprising:
authenticating usage by generating the log-on when the usage is authenticated and generating the log-off when the usage is not authenticated.

6. The method of claim 4 further comprising:
detecting an opening or closing action of the pressing plate; and
determining the angle of the pressing plate.

7. A computer-readable non-transitory storage medium having instructions that, when executed by a machine or a processor, cause the machine or the processor to performs operations comprising:
detecting a size of an original on a contact glass when an angle of a pressing plate is within a predetermined range;
storing information of the detected size of original;
reading the original on the contact glass, using the information of the stored size of the original after a log-on; and
updating the stored size of the original, along with a log-off.
